(19) United States
(12) Patent Application Publication
(10) Pub. No.: US 2025/0162501 A1
(43) Pub. Date: May 22, 2025

(54) VEHICLE EXTERIOR LIGHTING SYSTEM

(71) Applicant: Hella GmbH & Co. KGaA, Lippstadt (DE)

(72) Inventor: Ralf Edelmeier, Herzebrock-Clarholz (DE)

(21) Appl. No.: 18/950,891

(22) Filed: Nov. 18, 2024

(30) Foreign Application Priority Data
Nov. 21, 2023 (DE) 102023132355.5

(51) Int. Cl. B60Q 11/00; H05B 45/56

(52) U.S. Cl. CPC B60Q 11/005; H05B 45/56

(57) ABSTRACT

A vehicle exterior lighting system includes at least one lighting unit and a control system. At least one temperature detected by a vehicle temperature sensor is sent to the control unit when in use, and the control unit controls performance of the at least one lighting unit based on the at least one temperature. The control system includes a temperature modeling unit provided with a temperature model for each lighting unit, which is configured to determine at least one current temperature for each lighting unit based on the at least one temperature provided by the respective temperature model.

### CROSS REFERENCE

This application claims priority to German Application No. 10 2023 132355.5, filed Nov. 21, 2023, the entirety which is hereby incorporated by reference.

### FIELD OF THE INVENTION

The present invention relates to a lighting system for a vehicle exterior, comprising at least one lighting unit, and a control system to which at least one temperature detected by a vehicle temperature sensor is sent, which is configured to control the performance of the at least one lighting unit based on this at least one temperature.

### BACKGROUND OF THE INVENTION

This type of vehicle exterior lighting system is disclosed in DE 10 2021 100 092 A1.

### BRIEF SUMMARY OF THE INVENTION

The fundamental object of the present invention is to create a relatively inexpensive and easily installed vehicle exterior lighting system.

The vehicle exterior lighting system obtained with the invention comprises at least one lighting unit for lighting the area outside a vehicle equipped with this lighting system. The at least one lighting unit is preferably a headlamp and/or taillamp, particularly preferably containing LED light sources. Fundamentally, this can be any lighting unit for lighting the area outside a vehicle. The vehicle exterior lighting system obtained with the invention preferably comprises two headlamps and/or two taillamps.

This vehicle exterior lighting system also contains a control system to which at least one temperature detected by a vehicle temperature sensor is sent, which is configured to control the performance of the at least one lighting unit based on this at least one temperature. The at least one vehicle temperature sensor can basically be any temperature sensor in the vehicle, e.g. for detecting the ambient temperature, or the vehicle motor or battery temperature. Numerous temperatures are preferably sent to the control system from different vehicle temperature sensors. The control system is configured to control the performance of the at least one lighting unit such that it, or its components, do not overheat. The control system is electrically connected to the at least one lighting unit in the conventional manner, in order to be able to control the performance thereof. The control system comprises at least one control unit installed in the vehicle. The control system preferably comprises numerous separate control units installed in different areas in the vehicle. The control system for the vehicle exterior lighting system is preferably obtained through appropriate programming of numerous control units in the vehicle, such that additional control units are not needed for the control system in the vehicle exterior lighting system obtained with the invention.

The control system used in the invention contains a temperature modeling unit, provided with a temperature model for each lighting unit in the vehicle exterior lighting system that plots a thermal behavior of the respective lighting unit. This temperature modeling unit is advantageously provided with an individual temperature model for each lighting unit in the vehicle exterior lighting system. Conceivably, the temperature modeling unit could be provided with a temperature model for numerous lighting units, e.g. both headlamps or taillamps. Either way, a temperature model is provided to the temperature modeling unit for each lighting unit in the vehicle exterior lighting system. This temperature modeling unit is configured to determine the current temperature of each lighting unit from the at least one temperature sent to it based on the respective temperature model. The temperature modeling unit is preferably obtained through appropriate programming of a control unit in the vehicle, particularly preferably a control unit with a high-performance computing unit. The temperature model is preferably stored in this control unit in a standardized data format, such that the control system obtained with the invention can be easily configured to control different lighting units with temperature models that have been stored in this standardized data format. In addition to the at least one temperature, other data relating to the climate, e.g. current humidity and/or air pressure, could be sent to the temperature modeling unit, in which case the temperature modeling unit would be configured to take this other data into account when determining the current lighting unit temperature using the respective temperature model.

The temperature modeling unit obtained with the invention enables a precise determination of the current lighting unit temperature that is sufficient for controlling the performance of the at least one lighting unit, such that the need for temperature sensors in the at least one lighting unit is fundamentally eliminated, or substantially reduced. Consequently, the number of temperature sensors for the vehicle exterior lighting system, and therefore the wiring that would be required, can be significantly reduced from that required for a vehicle exterior lighting system according to the prior art, in which each lighting unit has at least one temperature sensor, thus resulting in a relatively inexpensive and easily installed vehicle exterior lighting system.

In a preferred embodiment of the vehicle exterior lighting system obtained with the invention, the control system is only sent temperatures from vehicle temperature systems outside the vehicle exterior lighting system. The vehicle lighting system in this embodiment therefore has no temperature sensors of its own, but instead uses only those temperature sensors already in the vehicle for other systems, resulting in a vehicle exterior lighting system that requires no additional temperature sensors. This results in a particularly inexpensive and easily installed vehicle exterior lighting system.

At least one current electrical operating parameter for each lighting unit is preferably sent to the temperature modeling unit when in use, and the temperature modeling unit is also preferably configured to determine the current temperature for each lighting unit based on this at least one current electrical operating parameter. This current electrical operating parameter can be the voltage, current, or electrical output currently supplied to a lighting unit. These electrical operating parameters for the at least one lighting unit can be sent to the temperature modeling unit from the control system or from a sensor system configured to detect these electrical operating parameters. The current temperature of the at least one lighting unit when it is in use can be precisely determined by taking these electrical operating parameters for into account.

In a preferred embodiment of the vehicle exterior lighting system obtained with the invention, the temperature modeling unit is sent a current vehicle speed and/or at least datum relating to the current airflow around the vehicle, and the temperature modeling unit is configured to also determine at least one current lighting unit temperature based on the speed and/or airflow. The airflow data can be obtained with a sensor system in the vehicle for determining airflows, or it can be determined on the basis of current driving information and/or weather data. By taking the speed and/or airflow data for the vehicle into account, a cooling of the at least one lighting unit obtained through the airflow can be modeled, resulting in a particularly precise determination of the current temperature of the at least one lighting unit.

At least some information regarding the route the vehicle is travelling is preferably sent to the temperature modeling unit by a navigation system when in use, and the temperature modeling unit is configured to also determine at least one lighting unit temperature that can be expected on the basis of this route information using the respective temperature model, wherein the control system is configured to control the performance of the at least one lighting unit based on this anticipated temperature. This enables a proactive control of the lighting unit performance, resulting in a particularly reliable and effective vehicle exterior lighting system. The route information can contain data regarding the topography of the route, weather information, and/or information regarding tunnels, for example.

In a preferred embodiment, the control system contains a central control unit, in which the temperature modeling unit is formed, and at least one peripheral control unit. The central control unit is configured to send at least one temperature parameter and/or at least one control parameter to each peripheral control unit, and each peripheral control unit is configured to control the performance of at least one lighting unit on the basis of the at least one temperature parameter and/or control parameter. The central control unit is preferably connected to the at least one peripheral control unit by a bus system in the vehicle. The central control unit preferably comprises a high-performance computing unit and not only functions as the temperature modeling unit, but also assumes all the other computing functions of the control system, such that the at least one peripheral control unit does not have to contain a particularly powerful computing unit. This results in an efficient control system and therefore an efficient vehicle exterior lighting system. The computing needed to determine the at least one lighting unit temperature with the at least one temperature model could also be distributed between the central control unit and the peripheral control units, such that the temperature modeling unit is formed by a composite of the central control unit and the peripheral control units.

In a preferred embodiment, the at least one lighting unit in the vehicle exterior lighting system contains power electronics that supply electricity to the one or more light sources in the respective lighting units. The temperature modeling unit is then preferably configured to determine a current temperature for the respective lighting unit using the temperature model, which then indicates the temperature of the power electronics, and the control system is configured to control the performance of the respective lighting unit on the basis of the current temperature thereof, indicating the temperature of the power electronics, to reliably prevent overheating of the power electronics.

In a preferred embodiment, the at least one lighting unit in the vehicle exterior lighting system contains numerous light sources, typically LEDs, with which a particularly variable adjustment of the lighting of the vehicle's exterior can be obtained. In this case, the temperature modeling unit is configured to individually determine the current temperatures of the numerous light sources using the temperature models for the respective lighting units, and the control system is configured to control the performances of the numerous light sources on the basis of the current lighting unit temperature, to reliably prevent overheating of the individual light sources.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a block diagram of various systems of a vehicle according to an example embodiment.

### DETAILED DESCRIPTION OF THE DRAWINGS

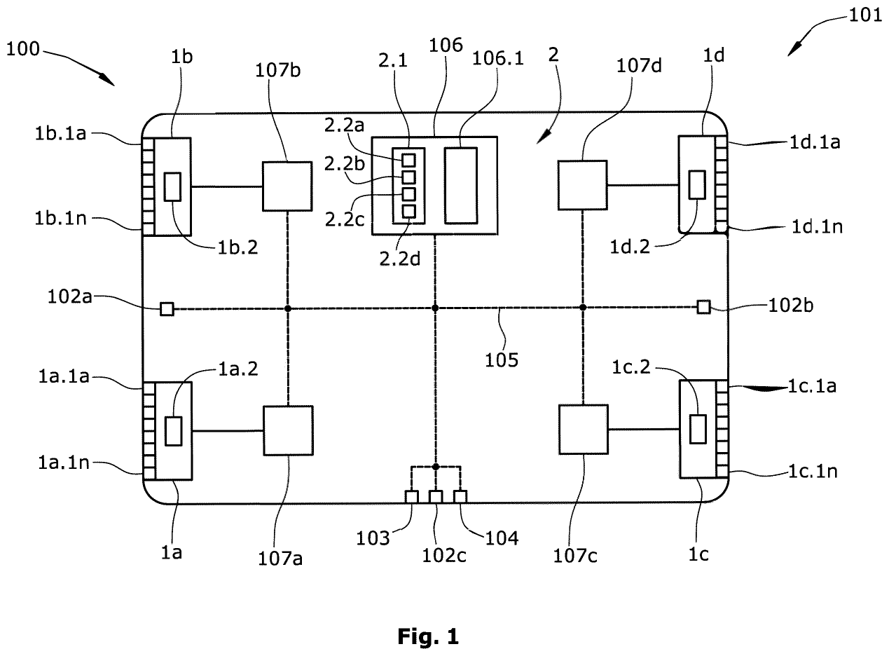

FIG. 1 shows a vehicle 101 that has a vehicle exterior lighting system 100, three vehicle temperature sensors 102a-102c, a vehicle air pressure sensor 103, a vehicle humidity sensor 104, a vehicle bus system 105, a central control unit 106, and four peripheral control units 107a-107d.

The vehicle exterior lighting system 100 contains four lighting units 1a-1d, the first of which, lighting unit 1a, is the left headlamp, the second, lighting unit 1b, is the right headlamp, the third, lighting unit 1c, is the left taillamp, and the fourth, lighting unit 1d, is the right taillamp.

The lighting units 1a-1d each contain numerous light sources 1a.1a-1a.1n, 1b.1a-1b.1n, 1c.1a-1c.1n, and 1d.1a-1d.1n that can be controlled individually, and can each fundamentally contain a different number of light sources 1a.1a-1a.1n, 1b.1a-1b.1n, 1c.1a-1c.1n, and 1d.1a-1d.1n. Each of the lighting units also contains power electronics 1a.2, 1b.2, 1c.2, 1d.2.

The vehicle temperature sensors 102a-102c are in different parts of the vehicle 101 and connected to the vehicle bus system 105, the first of which, sensor 102a, is in the motor well in the front of the vehicle 101, the second, sensor 102b, is in the rear of the vehicle 101, and the third, sensor 102c, is placed on the vehicle 101 where it can detect the exterior temperature in the vehicle's environment. None of these sensors 102a-102c is inside any of the four lighting units 1a-1d.

The vehicle air pressure sensor 103 and humidity sensor 104 are connected to the bus system 105 and placed on the vehicle 101 such that the air pressure sensor 103 can detect the exterior air pressure, and the humidity sensor 104 can detect the exterior humidity in the vehicle's environment.

The central control unit 106 contains a high-performance computing unit and is connected to the vehicle bus system 105. The central control unit 106 also contains a navigator 106.1 programmed into the central control unit 106.

Each of the four peripheral control units 107a-107d are electrically connected to one of the four lighting units 1a-1d, the first of which, peripheral control unit 107a, is connected to the first lighting unit 1a, the second, peripheral control unit 107b, is connected to the second lighting unit 1b, the third, peripheral control unit 107c, is connected to the third lighting unit 1c, and the fourth, peripheral control unit 107d, is connected to the fourth lighting unit 1d. The four peripheral control units 107a-107d are also connected to the vehicle bus system 105.

The vehicle exterior lighting system 100 contains a control system 2 that is programmed into the central control unit 106 and the four peripheral control units 107a-107d.

The four peripheral control units 107a-107d are configured by their programming to control the performances of the light sources 1a.1a-1a.1n, 1b.1a-1b.1n, 1c.1a-1c.1n, and 1d.1a-1d.1n in the respective lighting units 1.1-1.4 on the basis of the control parameter or temperature parameter obtained from the central control unit 106 through the bus system 105, and send current electrical operating parameters for the respective lighting units 1a-1d to the central control unit 106 through the bus system 105.

The control system 2 contains a temperature modeling unit 2.1 obtained through the programming of the central control unit 106, in which an individual temperature model 2.2a-2.2d is stored for each lighting unit 1a-1d, which plots a thermal behavior of the respective lighting unit 1a-1d.

The temperature modeling unit 2.1 is sent the current electrical operating parameter for the four lighting units 1a-1d through the bus system 105, which is formed by the current temperature detected by the temperature sensors 102a-102c, the current external air pressure detected by the air pressure sensor 103, and the current external humidity detected by the humidity sensor 104. The temperature modeling unit 2.1 is also sent route information from the navigator 106.1, and the current speed of the vehicle.

The temperature modeling unit 2.1 is configured to determine at least one current temperature and at least one anticipated temperature for the four lighting units 1a-1d using the respective temperature models 2.2a-2.2d, based on the current electrical operating parameters for the four lighting units 1a-1d, the current temperatures, the current external air pressure, the current external humidity, the route information, and the current speed of the vehicle.

The temperature modeling unit 2.1 is specifically configured to determine an individual current temperature and an individual anticipated temperature for each light source 1a.1a-1a.1n, 1b.1a-1b.1n, 1c.1a-1c.1n, and 1d.1a-1d.1n and for the power electronics 1a.2, 1b.2, 1c.2, 1d.2 in each of the four lighting units 1a-1d, using the temperature models 2.2a-2.2d for the respective lighting units 1a-1d.

In a first embodiment, the central control unit 106 is programmed to send the determined current temperatures and anticipated temperatures forming the temperature parameters for the lighting units 1a-1d to the peripheral control units 107a-107d controlling them through the bus system 105.

In an alternative embodiment, the central control unit 106 is configured to determine individual control parameters for the individual light sources 1a.1a-1a.1n, 1b.1a-1b.1n, 1c.1a-1c.1n, and 1d.1a-1d.1n, based on the determined current lighting unit temperatures and the anticipated lighting unit temperatures, and send these control parameters to the peripheral control units 107a-107d through the bus system 105 to control the lighting units 1a-1d.

The central control unit 106 could also be configured to send both the temperature parameters and the control parameters to the peripheral control units 107a-107d through the bus system 105.

### LIST OF REFERENCE SYMBOLS

100 vehicle exterior lighting system
1a-1d lighting units
1a.1a-1a.1n light sources
1a.2 power electronics
1b.1a-1b.1n light sources
1b.2 power electronics
1c.1a-1c.1n light sources
1c.2 power electronics
1s.1a-1d.1n light sources
1d.2 power electronics
2 control system
2.1 temperature modeling unit
2.2a-2.2d temperature models
101 vehicle
102a-102c vehicle temperature sensors
103 vehicle air pressure sensor
104 vehicle humidity sensor
105 vehicle bus system
106 central control unit
106.1 navigator
107a-107d peripheral control units

1. A vehicle exterior lighting system comprising:
at least one lighting unit, and
a control system to which at least one temperature detected by a vehicle temperature sensor is sent when in use, wherein the control system is configured to control performance of the at least one lighting unit based on the at least one temperature,
wherein the control system includes a temperature modeling unit provided with a temperature model for each lighting unit, the temperature modeling unit being configured to determine at least one current temperature for each lighting unit based on the at least one temperature provided by the respective temperature model.

2. The vehicle exterior lighting system according to claim 1, wherein the control system is only sent temperatures from vehicle temperature sensors outside the vehicle exterior lighting system.

3. The vehicle exterior lighting system according to claim 1, wherein the temperature modeling unit is sent at least one current electrical operating parameter for each lighting unit when in use, wherein the temperature modeling unit is also configured to determine the at least one current temperature for each lighting unit based on the at least one current electrical operating parameter for the respective lighting unit.

4. The vehicle exterior lighting system according to claim 1, wherein the temperature modeling unit is sent a current vehicle speed and/or at least one datum regarding current airflow when in use, wherein the temperature modeling unit is also configured to determine the at least one current lighting device temperature for each lighting unit based on the vehicle speed and/or this airflow data.

5. The vehicle exterior lighting system according to claim 1, wherein the temperature modeling unit is sent at least one route datum when in use, wherein the temperature modeling unit is also configured to determine at least one anticipated temperature for each lighting unit based on the at least one route datum using the respective temperature model, wherein the control system is configured to control the performances of these lighting units based on their anticipated temperatures.

6. The vehicle exterior lighting system according to claim 1, further comprising a central control unit and at least one peripheral control unit, wherein the temperature modeling unit is formed by the central control unit, wherein the central control unit is configured to send at least one temperature parameter and/or at least one control parameter to each peripheral control unit, wherein each peripheral control unit is configured to control the performance of at least one lighting unit based on these temperature parameters and/or control parameters.

7. The vehicle exterior lighting system according to claim 1, wherein at least one lighting unit contains power electronics, wherein the temperature modeling unit is configured to determine a current temperature for each lighting unit using the temperature model, which indicates a temperature of the power electronics.

8. The vehicle exterior lighting system according to claim 1, wherein the lighting units each contain numerous light sources, wherein the temperature modeling unit is configured to individually determine current temperatures of the numerous light sources using the temperature model for each lighting unit, wherein the control system is configured to control the performances of the numerous light sources based on the current temperatures of the respective light sources.
